(19) United States
(12) Patent Application Publication
(10) Pub. No.: US 2011/0314064 A1
(43) Pub. Date: Dec. 22, 2011

(54) Notifications Platform

(75) Inventors: Thomas Anand Jeyaseelan, Kirkland, WA (US); Suresh Parameshwar, Hyderabad (IN); Deepak B. Mukunthu, Hyderabad (IN); Brad Michael Marrs, North Bend, WA (US); Andrew E. Cunningham, Seattle, WA (US); Kerstin Weinberg, Seattle, WA (US)

(73) Assignee: Microsoft Corporation, Redmond, WA (US)

(21) Appl. No.: 12/816,402

(22) Filed: Jun. 16, 2010

(51) Int. Cl. G06F 17/30; G06F 9/46

(52) U.S. Cl. 707/803; 719/314; 707/E17.044

(57) ABSTRACT

Described is a notifications platform that routes notifications to endpoints of recipients, corresponding to email, instant messaging, text messaging, telephones, social networks, blogs and/or the like. A publisher of a notification designates the recipients, while preference data of each recipient determines whether that publisher is able to send to that recipient, and if so, to which endpoints. The notification may be modified via one or more templates to be appropriate for a locale of the recipient, as well as appropriately formatted for the endpoint, which may also be locale-specific.

### BACKGROUND

There are many ways in which users communicate information with one another, including email, instant messaging, text messaging, telephones, over social networks, via blogs and microblogs (e.g., Twitter®) and so forth. Windows Live® is an example of a set of services and software products that among other aspects may be used for such communications, including via mobile device services and products.

When a user event occurs in a service such as Windows Live®, it would be desirable to notify an audience of users about the event. However, doing so is not as straightforward as sending a notification to everyone associated with that event. More particularly, each of these users may need to be notified in one or more ways, using any combination of methods prevalent on the Internet and/or mobile devices, such as e-mail, SMS, a website or some custom mechanism. Further, users are in different locales, and thus notifications may need to be appropriate for each locale. Additionally, web services and other web applications may need to be notified about the event.

At the same time, notifications of the event need to respect privacy and security settings for each user. Notifications also need to be delivered in a medium that is optimized for the market the user is in. For example, users in markets such as Japan want to receive notifications in the most optimized delivery channel, such as mobile e-mail.

What is needed is a platform that meets these needs, in a manner that is customizable and easily authored, while supporting different locales (markets). Such a platform also needs to be able to support new types of events and technologies as they evolve.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a notifications platform that routes notifications to endpoints of one or more recipients, in which a publisher and/or other mechanism designates the recipients, e.g., the potential recipients may be arbitrarily specified, such as chosen by the publisher and/or derived from the notification type, and so forth. Preference data of each recipient determines whether that publisher is able to send to that recipient, and if so, to which endpoint set (one or more endpoints) of that recipient. Data associated with a notification thus is used to identify the potential recipients, and the platform accesses a preference data store to determine whether each potential recipient is an actual recipient to be sent the notification. If so, for each actual recipient, the platform determines the endpoint or endpoints based upon the recipient's preferences, that will receive the notification, formats a notification payload appropriate for that endpoint and market, and sends the notification payload to that endpoint.

In one aspect, when the notification payload is sent to a recipient, the recipient may reply to an incoming notifications pipeline. The incoming notifications pipeline determines the notification associated with the reply, and processes the reply based upon the associated notification.

In one aspect, notification data identifies a publisher, a recipient set of one or more potential recipients for receiving a notification, type information, and possibly arbitrary data that describes the notification, e.g., the comment content of a comment notification. The notification data is processed, including accessing preference data for each potential recipient to determine, based upon the publisher and type information, whether the notification is allowed to be sent to that recipient. If so, the preference data and notification type is used to locate an endpoint set (one or more endpoints) to which the notification is able to be sent, e.g., the intersection of the recipient's preference data and the notification type's (scenario). For example, the type information may comprise a scenario for the notification data; the preference data locates one or more roles for the selected scenario, in which each role corresponds to an endpoint and includes information that identifies whether the publisher is allowed to publish to that endpoint. One or more conditions, such as a “quiet” time in which notifications are not to be sent, also may be present in the preference data and evaluated for determining whether the notification can be sent to a given endpoint. If one endpoint is not available, a fallback endpoint may be used, based upon recipient preferences

In one aspect, a notification directed to a recipient and an endpoint of that recipient is processed, to modify the notification for the recipient and/or the endpoint. A notifications template is selected based upon information associated with the notification and locale information associated with the recipient, and used to obtain layout properties for that notification. A UI template is determined based upon the endpoint, and used with the layout properties to obtain a notification payload that is then sent to the endpoint of the recipient. The UI template may be selected based upon the locale information.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIGS. 1-3 comprise a representation of an example notifications platform illustrating how a publisher-provided notification is processed through the platform for delivery to an endpoint.

FIG. 4 is a representation of an example data structure for a notification.

FIG. 5 is an example diagram showing a notification associated with notification service instances of recipients.

FIG. 6 is an example diagram showing notification service instances of a recipient used to determine recipient preferences with respect to a notification scenario.

FIG. 7 is an example diagram showing notification data being formatted by a notifications template into layout properties.

FIG. 8 is an example diagram showing variable data (corresponding to layout properties) being formatted by a UI (user interface) template and transposed into a payload for communication to an endpoint.

FIG. 9 is an example showing how a UI template combines with variable data/layout properties into a payload.

FIG. 10 shows an illustrative example of a computing environment into which various aspects of the present invention may be incorporated.

### DETAILED DESCRIPTION

Various aspects of the technology described herein are generally directed towards a delivery platform for notifications, by which various software systems including web services and clients may originate and propagate a notification. As will be understood, the platform delivers the notifications in a performant and scalable manner, while respecting the privacy, security and other preferences of recipients (users and/or other applications) interested in receiving the notification. Further, the platform is configured to tailor the notification in a virtually unlimited variety of formats for different markets (locales).

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and data communication in general.

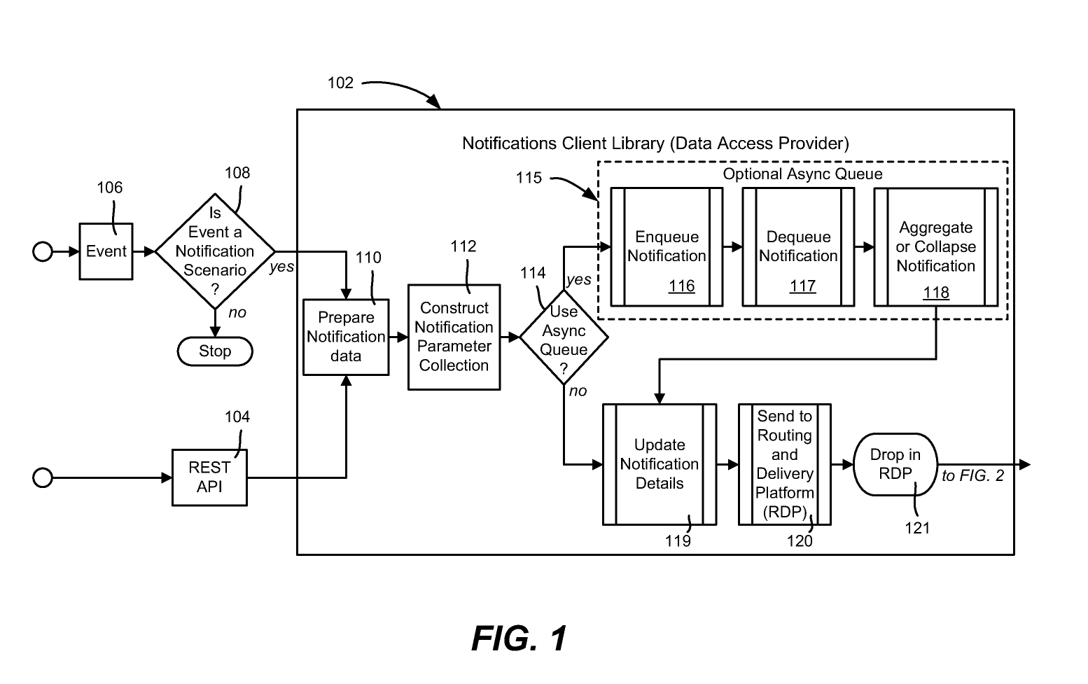

FIGS. 1-3 comprise a representation of a notifications platform/system showing various components and/or logic by which a notification is sent to one or more recipients. In general, a first part of the notifications platform provides multiple entrypoints, including a notifications client library 102 (data access provider) entrypoint, which provides an asynchronous task that allows a notification to be fired without affecting the performance of the client sending the notification. In the example of FIG. 1, a REST (representational state transfer) API 104 provides an entrypoint for programs, particularly external web services, to securely send a notification. For example, a social networking site may send a notification through the platform when a user updates content or otherwise uses that social networking site in a manner related to a communication.

Another way to enter a notification into the platform is via a program or the like on a user (client) device that fires an event 106 received at the platform. If the event comprises a notification scenario as evaluated by block 108, such as when the user sends an email, text message, instant message, and/or other communication to one or more recipients, a notification corresponding to the event enters the client library 102. More specific examples of such events include when a user adds a comment to some content, tags a person in a photo, shares a document, sends a message, issues a friend invitation, and so forth.

The notifications platform thus provides clients and services with the ability to generate notifications from various programs and/or sources in a virtually unlimited variety of formats and protocols, including e-mail, SMS, REST, XML, HTML, social networking, microblog and so forth. As can be readily appreciated, other interfaces may be provided as entrypoints into the notifications platform, including as technology evolves.

In general, a notification comprises a piece of data directed towards informing a recipient about the event that created that notification. Examples of events include adding a comment to a Windows Live® activity or a photo, tagging a photo, creating a group, adding a blog post and so forth.

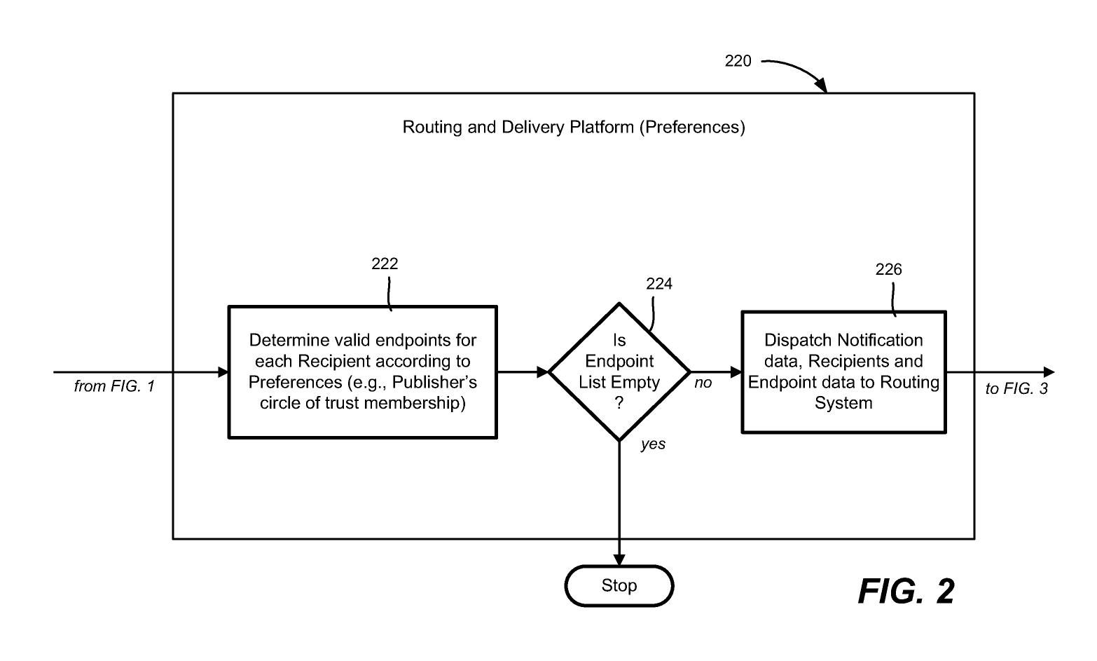

In one implementation, generally represented in FIG. 4, a notification comprises various notification-related information/parameters 440-442 and optional custom data 443, such as encapsulated into an object or other suitable data structure. The identifier (ID) 440 of a notification identifies the notification in a way that is (at least) platform-unique. In this implementation, the ID 440 comprises a platform-unique token, and categorical information comprising a scenario, an Application ID (also App ID) and a Change Type. The platform-unique ID is a string that may be used to assert whether two notifications are identical. A platform-unique ID is associated with a notification instance, and therefore is typically created when a notification is created during normal operation, such as represented by blocks 110 and 112 of FIG. 1.

The application ID and Change Type are values assigned to the notification that indicate the specific type of the notification; (as described below, the scenario indicates the general type of the notification). These values form a notification taxonomy; different types of events generate notifications with platform-unique application IDs and Change Types. The following table provides some examples of notifications each with a AppID/Change Type (and scenario, described below):

| | | Change | |
|---|---|---|---|
| Notification for Event | App ID | Type | Scenario |
| Adding a comment to a photo | 1 | 1 | comment |
| Adding a comment to a status | 2 | 5 | comment |
| message | | | |
| Adding a tag to a photo | 20 | 2 | tag |
| Adding a private message | 231 | 1002 | privatemessage |

The example values shown for App ID and Change Type are integers with no intrinsic significance herein other than that they are different for different types of notifications, and do not change during the lifetime of a service. App ID and Change Types are thus permanently assigned to a particular type of notification, and new numbers are provisioned when a new notification type is introduced to the platform. Note that there may be more than one instance of a platform (e.g., a test platform and a production platform), whereby there may be a different appid/change type duple or the like associated with a notification type in each instance.

Another part of the identifier (ID) 440 of a notification is the scenario property. While the AppID and Change Type pair provides a differentiator between notification types, this pair is specific to a notification type, and thus differentiates between a notification for a comment added to a photo and one for a comment added to an album, for example. However, there are times that these types benefit from being considered collectively to represent user preferences for the notifications with these types, which is what the scenario property accomplishes, namely that different notification types that need to share the same notifications settings have the same scenario. As can be seen, the scenario provides group categories for notification types. The scenario can be further categorized using a “category” attribute. This allows a set of notifications to share the same default settings, while each defining different sets of provisioned endpoints and UI (through per-category*scenario UI templates).

Each notification is published by someone, or on behalf of someone, identified in the notification as the publisher 441. An example publisher is a Windows Live® user with a PUID (Passport Unique ID) and CID (Contact ID).

Each notification is directed towards (intended for sending to) one or more recipients 442 identified in the notification. A recipient is typically a user, but can be any suitable entity, such as an e-mail address. As described below, a recipient may receive the notification via one or more endpoints based on preference data, and thus determining to which of those endpoints the notification is to be sent part of the notifications platform.

The field 443 represents a custom data specific to the event/notification and the circumstances that created the event. By way of example, a comment notification may contain text that says a comment has been made along with URLs to a comment page and a profile page of the person who made the comment. Some or all of a publisher's content, such as text and/or an image may be included in the custom data of a notification.

As described below with reference to templates, custom data is represented in a notification as a collection of template variables. Template variables are data structures designed to carry data in a typed format; text template variables carry strings, HLink template variables are used for URLs, and so on. Custom data is useful in presenting the notification in a rich and interesting way to a recipient, when it arrives at the recipient via e-mail, SMS or some other format. The data may be used in the content of an e-mail message.

Once the notification is created, it will be sent (blocks 120 and 121, FIG. 1) from the notifications client library 102 (data access provider) to the next stage of the platform, comprising a routing and delivery platform (RDP). As described herein, the routing and delivery platform, includes a preferences stage 220 represented in FIG. 2, and a routing stage 330 represented in FIG. 3. In one implementation, the notification is sent to the preferences stage 220 of the RDP via an ASP.NET SOAP Web Service call.

However, before sending, as also represented in FIG. 1, there is an (optional) asynchronous queue 115 in the platform that may be used for various purposes. One benefit of queuing a notification is that a publisher may be able to cancel a notification, if the publisher acts quickly enough. Another benefit is that related notifications may be further processed in some way, such as to aggregate or collapse related notifications together, e.g., from the same publisher having the same scenario. Each notification provides a way (e.g., a key) to distinguish itself from other notifications, and relate it to those with which it can be aggregated/collapsed. For example, a delete notification can cancel an add notification with the same key, provided the delete notification is received in time, e.g., in a six second queuing timeframe.

A notification may be flagged (e.g., via an opaque key exposed to the asynchronous queue) as being directed towards the asynchronous queue 115, as detected at block 114. As represented in FIG. 1, if enqueued at block 116, at some time later the notification is dequeued at block 117, possibly along with related notifications that may then be aggregated/collapsed at block 118.

Whether queued or sent without queuing, block 119 provides the library 102 with an opportunity to update notification details before sending, such as to add a current timestamp, to modify the notification parameters to indicate it has been aggregated/collapsed, and so forth.

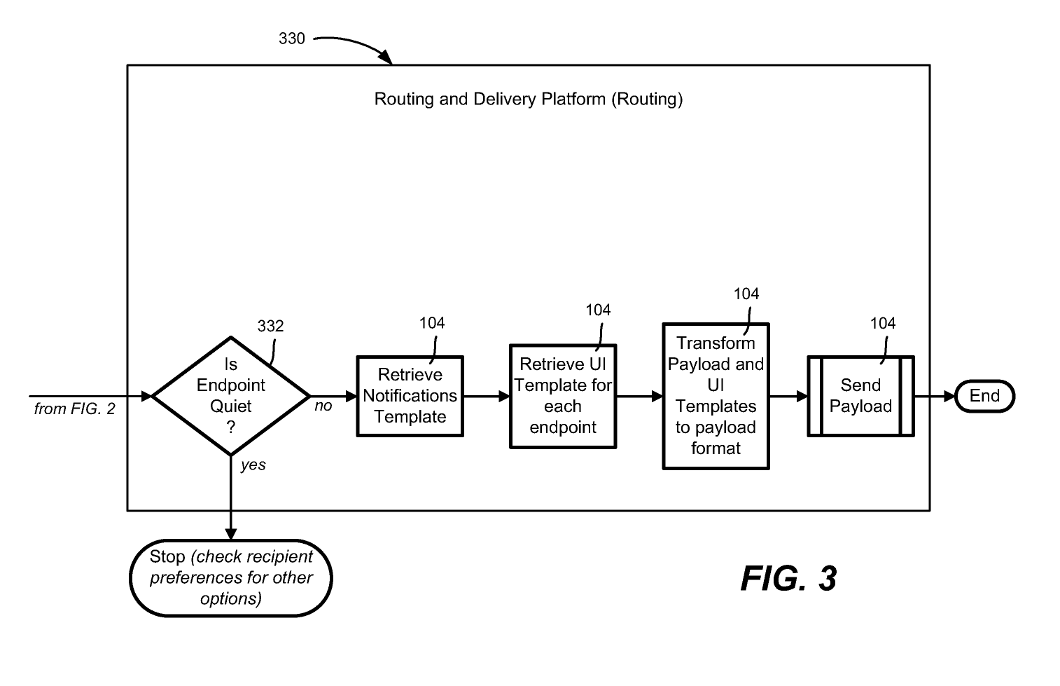

The preferences stage of the routing and delivery platform (RDP) 220 of FIG. 2 processes the notification by analyzing notifications preferences associated with each recipient, determining the endpoint or endpoints used to reach each recipient, and then routing the notification to each recipient via these endpoints. To this end, for each recipient identified in the notification, preference data is obtained and analyzed. For example, in a Windows Live® environment, preference data is recorded in a preferences store referred to the notifications service in each user's address book, e.g., in the ABCH (Address Book Clearinghouse) roles and sharing system; such preferences are stored as notifications service instances and the service type of each instance is “notifications.” FIG. 5 shows how a notification 550 is mapped to the notifications service instances 551-553 in the ABCH 554 for recipients R1-R3.

One determination that is made for each potential recipient is whether that recipient is actually interested in receiving the notification. More particularly, some people are not interested in receiving any notifications whatsoever. In other instances, recipients may elect to receive notifications from one publisher but not another, may only want certain types of notifications (e.g., “invites” but not “comments”), may want them delivered to a certain endpoint, may want them only during a certain time of day, and so forth. Such election information is recorded in the preferences data store.

Note that in one implementation, preferences are grouped by scenarios, e.g., a recipient may want to receive one publisher's invitations (invites), but not that same publisher's comments; (more granular elections may be used in alternative implementations, e.g., Application ID and/or Change Type may be used rather than (or in addition to) per-scenario elections). The RDP state 220 checks each recipient's preferences at block 222 to determine whether that potential recipient has elected to receive notifications from the publisher for the notification's particular scenario.

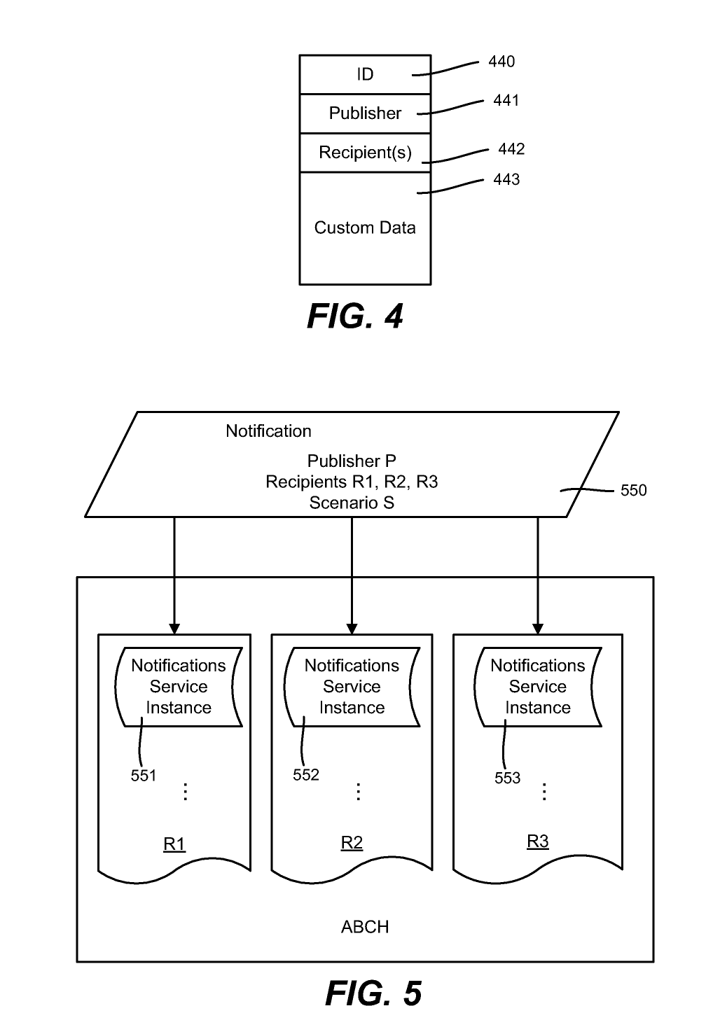

To this end, as generally represented in FIG. 6, each scenario has a notifications service instance (e.g., 661 for “comment” and 662 for “invite”) that contains role maps 663-668 for the recipient R1; each role map corresponds to a notification endpoint. Note that while the example of FIG. 6 shows three endpoints, namely an E-mail Endpoint, SMS Endpoint and Messenger Endpoint, not all of these three roles/endpoints may be present for a given recipient and/or provisioned for a given scenario, and/or other roles/endpoints may be present. For example, another endpoint may be a mobile and/or landline telephone that receives a spoken notification, such as using text-to-speech, which can be answered or recorded on voice mail.

To determine whether to notify recipient R1, a check preferences component 620 of RDP checks R1's address book and locates the notification service instance for the scenario described by the notification 650, which is “comment” (notification service instance 661) in the example of FIG. 6.

The RDP component 620 determines which of the roles 663-665 in the notification service instance 661 have members that contain the publisher P, either by identity or by belonging to a group within a role. For example, in a Windows Live® environment, members that contain P may be the Passport Member P or compound roles (such as RoleMember/ServiceMember roles) that contain P as one member, e.g., the Friends role may contain P if P is a member of R1.

Using the resulting roles, if one or more roles are found, RDP uses the roles (e.g., by their names, as each role may be named for an endpoint for which it contains preferences) to determine the endpoint or endpoints for contacting the recipient R1. For example, if R1 permits P to contact R1 for comment notifications via E-mail, R1 has added P (or a group of people including P) to the “E-mail” Role 663 in the notifications service instance 661 for “comment.” In this way, the RDP component 620 constructs a list 669 of one or more endpoints for contacting R1. This list may be empty if R1 has not chosen to receive notifications from P, or at least not comment notifications in this example. The process is repeated for any other recipients, such as R2 and R3 in the example of FIG. 5.

Note that the above model is an “include” type model in which the recipient includes users or groups from whom messages are permitted to be received. However, an “exclude” model may be convenient for certain users, in which anyone can send a notification, at least certain types of notifications, unless specifically excluded. Such an exclude model may be offered as well, although some spam filtering may be needed; an include model and an exclude model may be used together

Another aspect is a selection among multiple preferences. For example, instant messaging programs may detect whether a recipient is currently online (i.e., logged in for instant messages). If not, another endpoint is more appropriate for sending the notification. Thus, for example, a recipient may elect to receive a notification via instant message and SMS, but will only receive an instant message if online, and only SMS if offline; (it is alternatively possible to send to both endpoints if online). Alternatives are feasible, e.g., a recipient may elect to receive a notification via instant message, but if not online, then by email.

In the above model, the recipient specifies the preferences. However, a model in which the publisher has some input is an alternative. For example, in one possible alternative, a publisher may specify (e.g., for all notifications or per-notification) that if more than one endpoint is available, the notification be delivered in an order specified by the publisher, e.g., email if possible, then instant message if not, then SMS if neither, and so on. In such a model, each recipient may remain in charge of whether the publisher has the option to specify the order for that recipient.

Returning to FIG. 2, step 224 represents the RDP stage 220 determining whether the list is empty for this recipient. If no, then the notification data is dispatched along with the recipient(s) and endpoint data (block 226) to the RDP routing stage 330 of FIG. 3, which processes and routes the notification as described below.

In addition to notification election based upon publishers and scenarios, certain preference data may indicate one or more conditions such as certain times to not receive notifications. This may be a single “quiet” time window, such as no notifications between 10:00 pm and 7:00 am, however more elaborate schemes are feasible, e.g., different times for weekdays versus weekends, different quiet rules for different publishers and/or scenarios, and so forth. Step 332 of FIG. 3 represents stopping the notification if the endpoint is in such a “quiet” state; note that an alternative is to defer the notification until no longer in a quiet state, or access recipient preferences to possibly determine another endpoint. Other preferences and policies may be set, such as maximum message size, language translation of the content, and so on.

A publisher may also send notifications to a recipient outside the notifications platform, such as a third party social networking site. This is generally done to update the publisher's own information on such a site, for example, in which event a publisher is a recipient of the publisher's own notification. Thus, as used herein, the term “recipient” refers to any entity that receives a notification, including third party endpoints of the publisher that published the notification. Third-party endpoints of a recipient may also be contacted.

To send to such an outside entity, the notifications platform accesses the publisher's cached account information (e.g., username and credentials) for that entity, or obtains it as needed, and sends the notification to an activity publishing system or the like for publishing activities. In this way, for example, a publisher does not have to independently update his or her other sites and the like when performing some action that impacts them. The process works in reverse as well, e.g., other sites may be given access to the notifications platform so that a user only need perform some suitable action on a third party site, for example, to have a notification generated via the notifications platform. Note that the notifications platform includes a suitable mechanism to halt or drop a notification, so as to prevent an infinite looping of the update/notification between the third party entity and the notifications platform.

Another aspect of routing and delivery is preparing the data for the endpoints once the endpoints have been determined for each recipient. In one implementation, there are multiple sources of data, including the notification itself, particularly its custom data 443 (FIG. 4), and the notifications templates and UI templates (described below). These sources of data are used in preparing variable data, and writing the variable data into a static template.

More particularly, the notification provides the data that is specific to the particular situation that created the notification. For example, a comment notification contains the specific comment associated with the notification. However, the notification's custom data 443 is often very terse, precise and compact, because the notification contains only atomic pieces of information subsequently used for customization as described herein. For example, a comment notification may contain the first and last names and the profile URL of the publisher, however to look appropriate to a recipient reader, an e-mail message needs sentences or phrases that contained some or all of these pieces of information.

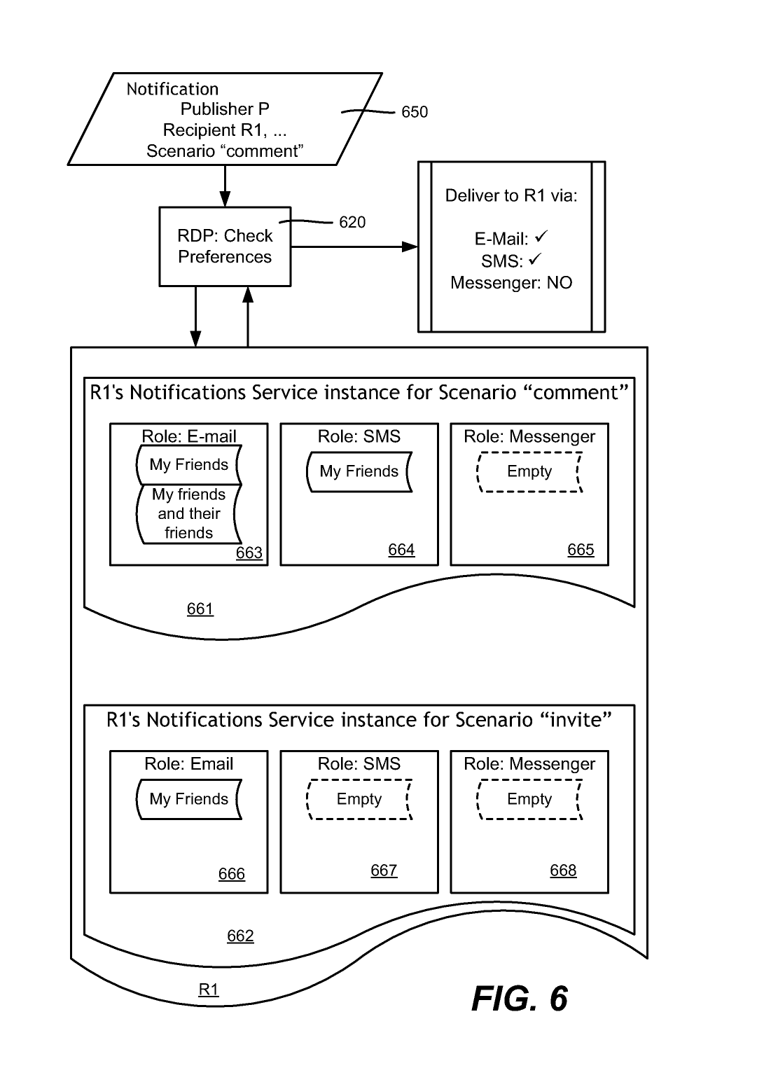

Thus, the custom data 443 may be extended to provide rich and extensive customizations, which is provided by a notifications templates service (block 334 of FIG. 3) and in general in FIG. 7. The notifications templates service provides a way to create compound data by combining different template variables 770 via Application ID and Change Type-based notifications templates 772 to form new compound data variables known as layout properties 774. Note that this is more specific than scenario (used for recipient preferences), e.g., a comment on a photograph is different from a comment on a status message; the Application ID and Change Type allow such specificity. The service also extracts specific data from rich template variables that have more than one piece of information, such as image template variables containing an image URL and an anchor URL.

The notification templates 772 contain mapping rules, referred to as layout styles, which translate the notification data 770 to the layout properties 774. Note that these templates may be per-designed and cached for efficiency. In one implementation, the RDP uses a notifications template REST API to obtain notification templates and get the layout properties for a particular notification. A notification template 772 exists for each type of notification, and is identified according to the AppID and Change Type of the notification, e.g., one notification template exists for each AppID-Change Type duple.

Below is an example of custom data for a notification described in template variables.

| Template Variable Name | Type | Remarks |
|---|---|---|
| Publisher_FirstName | Text | |
| Publisher_LastName | Text | |
| Publisher_Cid | Text | |
| IsGroupComment | Text | True/False |
| TargetOwnerCid | Text | |
| CommenterProfileUrl | HLink | |
| CommentPageUrl | HLink | |
| ResourceId | Text | |
| ActivityId | Text | Optional |
| Comment | Text | |

Notification templates 772 can create the following layout properties 774 for these variables; (not that this is an informational example and not necessarily an actual template):

| Layout Property | Value | Remarks |
|---|---|---|
| Subject | {text:Publisher_FirstName} | Only the first |
| | commented on your photo. | name is used |
| | | here. |
| FirstSentence | Hi, {text:Publisher_FirstName} | |
| | {text:Publisher_LastName} | |
| | commented on your photo. | |
| CommentPageUrlLink | {hlink:CommentPageUrl.Href} | This property |
| | | contains a raw |
| | | URL. The |
| | | hlink template |
| | | variable |
| | | contains more |
| | | information |
| | | that is |
| | | extracted out. |
| Comment | {text:Comment} | The comment. |

The layout properties 774 are localizable, such that there is a set of layout properties (layout styles) for each locale/market.

In this manner, the notification data 770 needed for an endpoint is transformed into a layout property 774, including any data that remains unaltered. Moreover, each endpoint has its own set of localized layout properties. Because each endpoint may need a particular message with its own content, a collection of layout properties along with their definition based on template variables may exist for each endpoint in the notifications template.

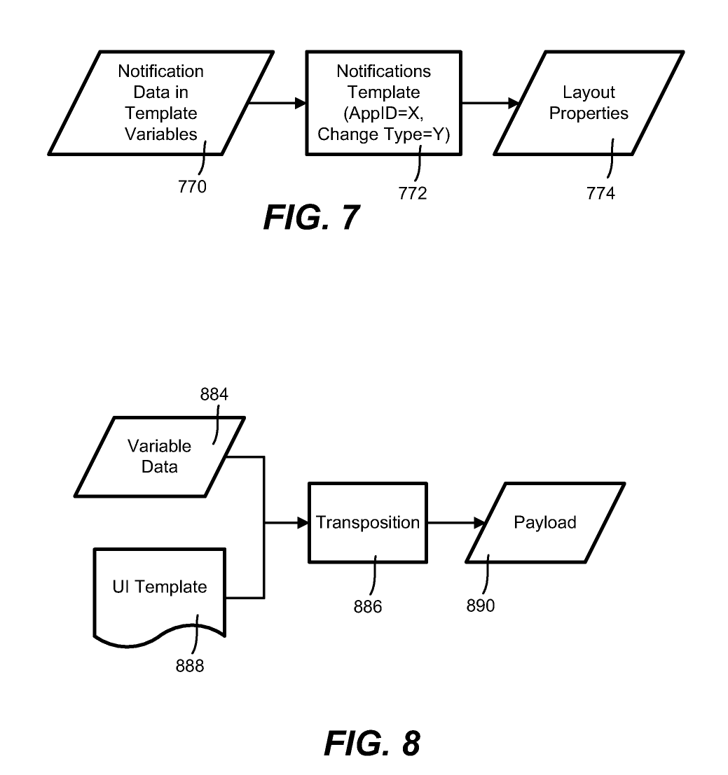

Layout properties provide the variable data 884 for a notification, as represented in FIG. 8. These variable data 884 are then adjusted for each different type of endpoint. More particularly, the RDP transposes (block 886) this variable data 884 into static templates, each referred to as a UI template 888, to form a final payload 890 for each endpoints. A UI template 888 typically contains markup such as HTML for rich e-mail, or XML, and are generally presented according to the specifications of an endpoint's payload format. Note that the UI template 888 is localizable. For example, some languages read right-to-left, another message may have a different logo in one locale versus another, and so on, and these situations are handled by having a suitable UI template for each locale.

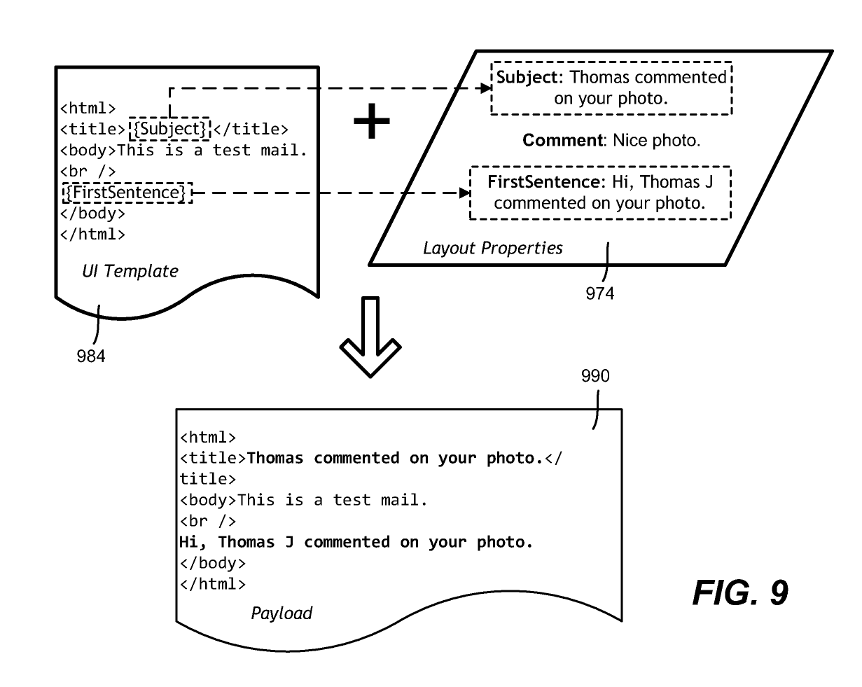

UI Templates contain static data (usually text) and placeholders with names of the layout properties that need to be inserted. An example placeholder format is {LayoutPropertyName}. Note that as described above, UI templates are also localizable, and e.g., one UI template exists for each endpoint and each supported market within that endpoint. FIG. 9 shows a more particular example of how a UI template 984 combined with layout properties 974 results in a payload 880 for a particular endpoint.

Another aspect of the notifications platform is a reply capability of a recipient, such as to comment back, accept an invitation, set up a “friend” relationship, and so forth. To this end, when a recipient receives a notification, the recipient may contact an incoming notifications pipeline. For each endpoint, there is metadata that facilitates reply handling, and each endpoint may have its own reply-handling system.

For example, a reply to an email message may be sent to an email address (e.g., a Hotmail® address) that contains certain information that identifies the message as a notification reply. The message is then routed (e.g., by Hotmail®) to a web service or the like that makes an API call to the incoming notifications pipeline. From the metadata with the message, the pipeline may locate the notification to which this reply is associated, and, for example, return an email message to the sender as a reply in the same email thread. Other endpoints are handled similarly, e.g., SMS and instant messaging replies may likewise be routed back and re-associated with a notification/message thread, or take some action such as to call a URL to accept an invitation.

### Exemplary Operating Environment

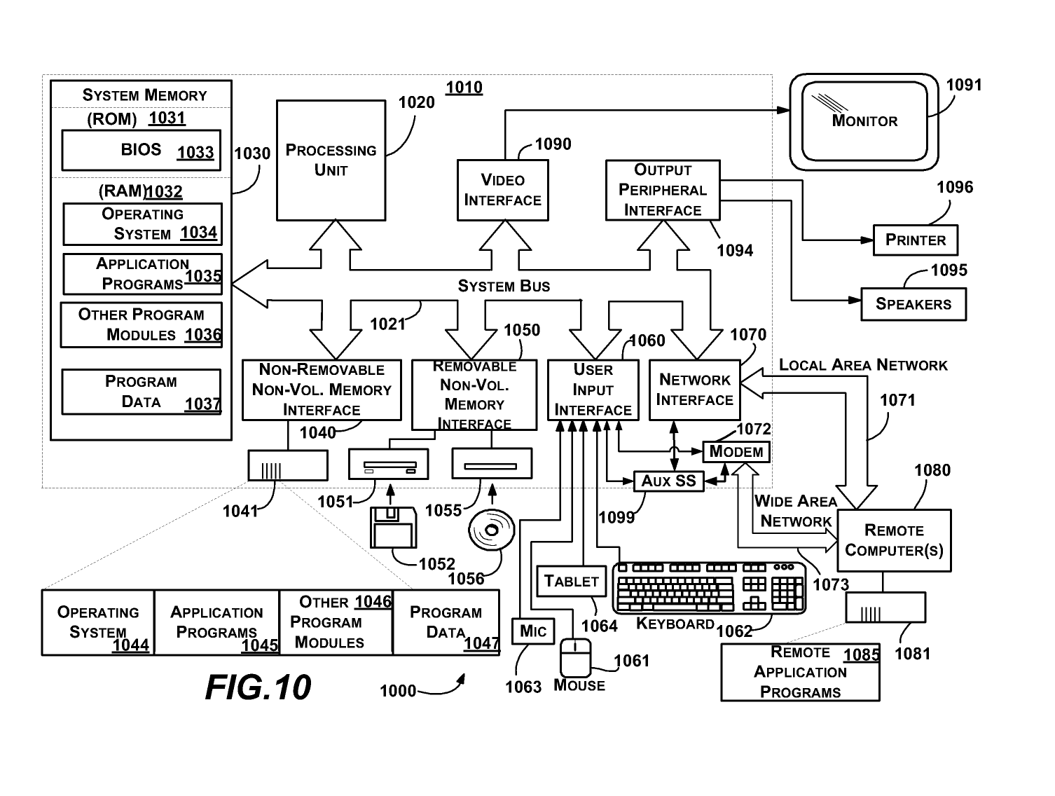

FIG. 10 illustrates an example of a suitable computing and networking environment 1000 on which the examples of FIGS. 1-9 may be implemented. The computing system environment 1000 is only one example of a suitable computing environment and is not intended to suggest any limitation as to the scope of use or functionality of the invention. Neither should the computing environment 1000 be interpreted as having any dependency or requirement relating to any one or combination of components illustrated in the exemplary operating environment 1000.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 10, an exemplary system for implementing various aspects of the invention may include a general purpose computing device in the form of a computer 1010. Components of the computer 1010 may include, but are not limited to, a processing unit 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1010 typically includes a variety of computer-readable media. Computer-readable media can be any available media that can be accessed by the computer 1010 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 1010. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036 and program data 1037.

The computer 1010 may also include other removable/non-removable, volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media, described above and illustrated in FIG. 10, provide storage of computer-readable instructions, data structures, program modules and other data for the computer 1010. In FIG. 10, for example, hard disk drive 1041 is illustrated as storing operating system 1044, application programs 1045, other program modules 1046 and program data 1047. Note that these components can either be the same as or different from operating system 1034, application programs 1035, other program modules 1036, and program data 1037. Operating system 1044, application programs 1045, other program modules 1046, and program data 1047 are given different numbers herein to illustrate that, at a minimum, they are different copies. A user may enter commands and information into the computer 1010 through input devices such as a tablet, or electronic digitizer, 1064, a microphone 1063, a keyboard 1062 and pointing device 1061, commonly referred to as mouse, trackball or touch pad. Other input devices not shown in FIG. 10 may include a joystick, game pad, satellite dish, scanner, or the like. These and other input devices are often connected to the processing unit 1020 through a user input interface 1060 that is coupled to the system bus, but may be connected by other interface and bus structures, such as a parallel port, game port or a universal serial bus (USB). A monitor 1091 or other type of display device is also connected to the system bus 1021 via an interface, such as a video interface 1090. The monitor 1091 may also be integrated with a touch-screen panel or the like. Note that the monitor and/or touch screen panel can be physically coupled to a housing in which the computing device 1010 is incorporated, such as in a tablet-type personal computer. In addition, computers such as the computing device 1010 may also include other peripheral output devices such as speakers 1095 and printer 1096, which may be connected through an output peripheral interface 1094 or the like.

The computer 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computer 1010, although only a memory storage device 1081 has been illustrated in FIG. 10. The logical connections depicted in FIG. 10 include one or more local area networks (LAN) 1071 and one or more wide area networks (WAN) 1073, but may also include other networks. Such networking environments are commonplace in offices, enterprise-wide computer networks, intranets and the Internet.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060 or other appropriate mechanism. A wireless networking component such as comprising an interface and antenna may be coupled through a suitable device such as an access point or peer computer to a WAN or LAN. In a networked environment, program modules depicted relative to the computer 1010, or portions thereof, may be stored in the remote memory storage device. By way of example, and not limitation, FIG. 10 illustrates remote application programs 1085 as residing on memory device 1081. It may be appreciated that the network connections shown are exemplary and other means of establishing a communications link between the computers may be used.

An auxiliary subsystem 1099 (e.g., for auxiliary display of content) may be connected via the user interface 1060 to allow data such as program content, system status and event notifications to be provided to the user, even if the main portions of the computer system are in a low power state. The auxiliary subsystem 1099 may be connected to the modem 1072 and/or network interface 1070 to allow communication between these systems while the main processing unit 1020 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising, a notifications platform that receives sets of notification data corresponding to notifications that are capable of being directed towards one or more potential recipients, and for each set of notification data:
accesses a preference data store to determine whether each potential recipient is an actual recipient to be sent the notification; and
for each actual recipient, determines an endpoint set comprising at least one endpoint corresponding to the actual recipient, and for each endpoint in the endpoint set, formats a notification payload for that endpoint and sends the notification payload to that endpoint.

2. The system of claim 1 wherein for each event corresponding to a notification, the notifications platform processes event data associated with that event into a notification data structure, the notification data structure comprising, a notification identifier, a publisher, a recipient set that identifies each of the one or more recipients, and custom data.

3. The system of claim 2 wherein the notification identifier comprises an application identifier, a change type and a scenario.

4. The system of claim 1 wherein the notifications platform includes an asynchronous queue that maintains at least some of the notifications as enqueued notifications, the notifications platform deleting at least some of the enqueued notifications, or processing at least some of the enqueued notifications before dequeuing.

5. The system of claim 1 wherein at least some of the sets of data corresponding to notifications comprise client events, and wherein the notifications platform includes a client library entrypoint for receiving the events, or an API entrypoint for receiving at least some of the sets of data, including sets of data from external web services, or wherein the notifications platform includes both a client library entrypoint for receiving the events and an API entrypoint for receiving at least some of the sets of data.

6. The system of claim 1 wherein the preference store comprises a set of zero or more notifications service instances for each potential recipient, each notifications service instance corresponding to a notifications scenario and comprising zero or more roles, each role corresponding to an endpoint.

7. The system of claim 1 wherein the notification includes an application identifier, a change type, wherein the platform notifications selects a notifications template based upon the application identifier and the change type to obtain layout properties, and wherein the notifications platform formats the notification payload using the layout properties and a UI template selected for the endpoint.

8. The system of claim 7 wherein the notifications template is selected based upon a locale associated with the actual recipient, or wherein the UI template is selected based upon a locale associated with the endpoint, or wherein both the notifications template is selected based upon a locale associated with the actual recipient and the UI template is selected based upon a locale associated with the endpoint.

9. The system of claim 1 wherein the endpoint set includes an e-mail endpoint, an SMS endpoint, an instant message endpoint, or an outside entity endpoint, or any combination of an e-mail endpoint, an SMS endpoint, an instant message endpoint, or an outside entity endpoint.

10. The system of claim 1 wherein the notification payload is sent to a recipient, and wherein the notifications platform includes an incoming notifications pipeline that receives a reply from the recipient that received the notification payload, the incoming notifications pipeline determining to which notification the reply is associated based upon metadata associated with the reply, and processing the reply based upon the notification associated with that reply.

11. In a computing environment, a method performed on at least one processor comprising:
processing notification data that identifies a publisher, a recipient set comprising one or more potential recipients for receiving a notification corresponding to the notification data, and type information of the notification data; and
for each potential recipient, accessing preference data associated with that recipient to determine based upon the publisher and type information whether the notification is allowed to be sent to that recipient, and if so, determining from the preference data an endpoint set comprising one or more endpoints to which the notification is able to be sent.

12. The method of claim 11 wherein the type information comprises a scenario for the notification data, wherein accessing the preference data includes determining a selected scenario from the type information and locating one or more roles for the selected scenario, each role corresponding to an endpoint and including information that identifies whether the publisher is allowed to publish to that endpoint.

13. The method of claim 11 further comprising, sending the notification to an endpoint, receiving data and metadata corresponding to a reply from the endpoint, and using the metadata to associate the reply with the notification.

14. The method of claim 11 further comprising, accessing the preference data associated with a recipient to determine based on one or more conditions whether the notification is able to be sent to that recipient.

15. The method of claim 14 wherein accessing the preference data associated with a recipient to determine based on one or more conditions whether the notification is able to be sent to that recipient, comprises determining whether the endpoint is in a quiet time.

16. One or more computer-readable media having computer-executable instructions, which when executed perform steps, comprising:
(a) processing a notification directed to a recipient and an endpoint of that recipient, including:
(i) determining a notifications template based upon information associated with the notification and locale information associated with the recipient;
(ii) using the notifications template and the information associated with the notification to obtain layout properties for that notification;
(iii) determining a UI template based upon the endpoint; and
(iv) using the UI template and the layout properties to obtain a notification payload;
and
(b) sending the notification payload to the endpoint of the recipient.

17. The one or more computer-readable media of claim 16 wherein determining a UI template based upon the endpoint includes selecting the UI template based upon the locale information.

18. The one or more computer-readable media of claim 16 having computer-executable instructions, comprising, receiving data and metadata corresponding to a reply from the endpoint, and using the metadata to associate the reply with the notification.

19. The one or more computer-readable media of claim 16 having computer-executable instructions, comprising, determining the recipient and the endpoint, including accessing preference data associated with that recipient, determining from the preference data that the notification is allowed to be sent to that recipient based upon a publisher of the notification and type information of the notification, and selecting the endpoint for that publisher and the type information.

20. The one or more computer-readable media of claim 19 wherein the type information comprises a scenario for the notification data, wherein accessing the preference data includes determining a selected scenario from the type information and locating a role for the selected scenario that corresponds to the endpoint, the role including information that identifies whether the publisher is allowed to publish to that endpoint.
